(19) United States
(12) Patent Application Publication
(10) Pub. No.: US 2008/0229062 A1
(43) Pub. Date: Sep. 18, 2008

(54) Method of sharing registers in a processor and processor

(76) Inventor: Lorenzo Di Gregorio, Muenchen (DE)

Correspondence Address: SLATER & MATSIL LLP, 17950 PRESTON ROAD, SUITE 1000, DALLAS, TX, 75252, US

(21) Appl. No.: 11/716,990

(22) Filed: Mar. 12, 2007

(51) Int. Cl. G06F 9/30

(52) U.S. Cl. 712/30; 712/E09.023

(57) ABSTRACT

A method of sharing registers in a processor includes executing a data processing instruction so as to obtain a result of the data processing instruction, which is to be written into a register of the processor. Register sharing information is obtained so as to control writing of the result into the register and/or at least one further register of the processor.

### BACKGROUND

The present invention relates to a method of sharing registers in a processor and to a correspondingly designed processor.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically illustrates a register sharing processor architecture according to an embodiment of the invention;

FIG. 2 schematically illustrates the structure of a register file in a processor according to an embodiment of the invention;

FIG. 3 shows a register sharing table according to an embodiment of the invention with exemplary register sharing information;

FIG. 4 shows a table which illustrates the memory mapping of the register sharing table according to an embodiment of the invention;

FIG. 5 shows an exemplary software code for acquiring and releasing a lock accordingly;

FIG. 6 schematically illustrates a register sharing processor architecture according to a further embodiment of the invention;

FIG. 7 schematically illustrates circuitry of the forwarding logic in the processor architecture of FIG. 6;

FIG. 8 shows the timing of signals for accessing a memory holding register sharing information, according to an embodiment of the invention; and

FIG. 9 illustrates an example of an application using shared registers.

### DETAILED DESCRIPTION OF ILLUSTRATIVE EMBODIMENTS

The following detailed description explains exemplary embodiments of the invention. The description is not to be taken in a limiting sense, but is made only for the purpose of illustrating the general principles of the invention. The scope of the invention, however, is only defined by the claims and is not intended to be limited by the exemplary embodiments described hereinafter.

It is to be understood that in the following description of exemplary embodiments any shown or described direct connection or coupling between two functional blocks, devices, components, or other physical or functional units could also be implemented by indirect connection or coupling.

The embodiments described hereinafter relate to a register sharing processor architecture and to a method of sharing registers of a processor. A corresponding processor may be used in a computer system for processing instructions of a program code. Further, a corresponding processor may be used in a communication device, e.g., as an embedded protocol processor for handling data packets. According to other embodiments, the register sharing processor architecture may be applied in other environments.

In data processing systems, it is known to use the concept of threads for executing program code. Generally, threads are a way for a program flow to split itself into a plurality of concurrent flows. In the following, a thread will be considered as a sequence of instructions to be carried out by a processor. Different threads running on a data processing system may share resources of the data processing system, such as memory or other resources. On the other hand, each thread may be provided with dedicated resources, which will in the following be referred to as a context. In this respect, a situation will be considered in which a register file of a processor is divided into a plurality of sets of registers, each of the sets of registers corresponding to a different context. By this means, each thread or context may be provided with its own set of registers. However, it may also be desirable to provide for information being passed between different threads or contexts.

According to an embodiment, the present invention proposes a method of sharing registers in a processor. The method comprises executing a data processing instruction and obtaining a result which is to be written into a register of the processor. A register sharing information is obtained. On the basis of register sharing information, the result is written into at least one register of the processor. That is to say, the writing of the result may be replicated according to the register sharing information so as to write the result into a plurality of registers. However, according to the specific register sharing information, it is also possible that the result is written into only one register or that said writing of the result is completely suppressed.

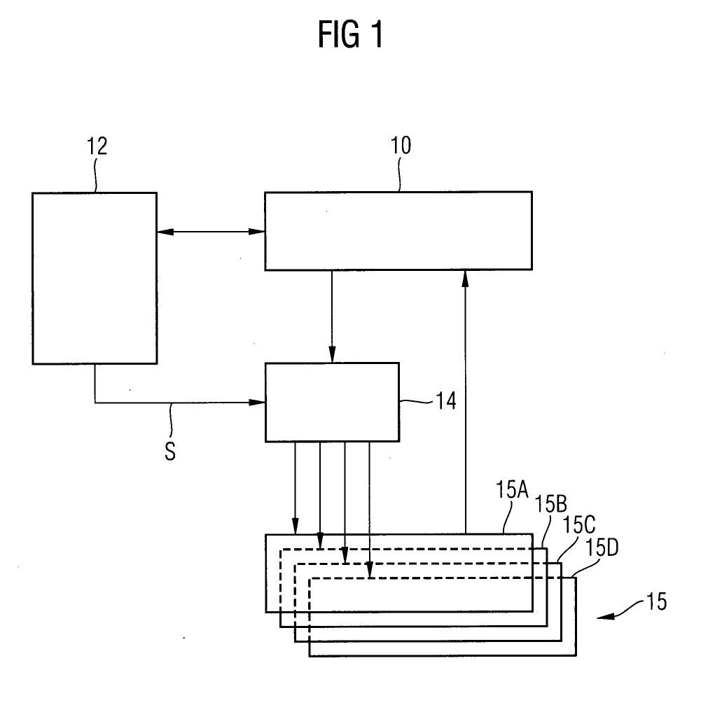

FIG. 1 schematically illustrates an embodiment of a register sharing processing architecture for implementing the above concept of sharing registers. According to the illustrated architecture, a processor comprises a processing stage 10, a register file 15, a memory 12 to hold register sharing information, and a write control 14. It is to be understood, that the processor may actually comprise further components. However, for the sake of clarity, it will be refrained from describing such further components in more detail.

The operation of the processor will be described as follows. The processing stage 10 is provided with an instruction to be executed, e.g., by an instruction decoder (not illustrated). The instruction may be provided with a number of arguments and returns a result. In particular, the arguments may be obtained from registers of the register file 15, and the result may be written into a register of the register file 15. One example of such an instruction is to add two registers and to write the result into a third register. The process of writing the result into the register is controlled by the write control 14. It is also possible that a type of instruction returns two or more results. In this case, each result is written into a corresponding register.

The register file 15 as illustrated in FIG. 1 comprises a plurality of sets of registers 15A, 15B, 15C, 15D, each corresponding to a different context. That is to say, if the instruction executed by the processing stage 10 belongs to a specific context, it will read its arguments from the corresponding set of registers 15A, 15B, 15C, 15D, and the result of the data processing instruction will normally be written into a register of the same set of registers. In this way, the processing of instructions may be confined to a single context.

For sharing information between different contexts, the following mechanisms are provided: A register sharing information is stored in a register sharing table stored in the memory 12. From the memory 12, register sharing data S is supplied to the write control 14. On the basis of the register sharing data, the result of the data processing instruction executed by the processing stage 10 is written into further registers of the register file. In particular, the result is not only written into the register of the context in which the data processing instruction is executed, but may also be written into the corresponding register of the other contexts. In this way, the result of the data processing instruction can be shared between different contexts. Further, the register sharing information may specify a register as locked so that its content may not be overwritten with the result of a standard instruction. This will be described in more detail below.

To manage the register sharing information and thereby control the sharing of information between different contexts, the processing stage 10 is coupled to the memory 12 so as to write and read the register sharing information. This is accomplished on the basis of specific instructions. However, the above concept of sharing registers does not require explicit instructions to accomplish the transfer of information between the different contexts. Rather, this transfer of information is accomplished in the course of writing the result of the data processing instruction into the register file. Accordingly, additional instruction cycles for transferring information can be avoided.

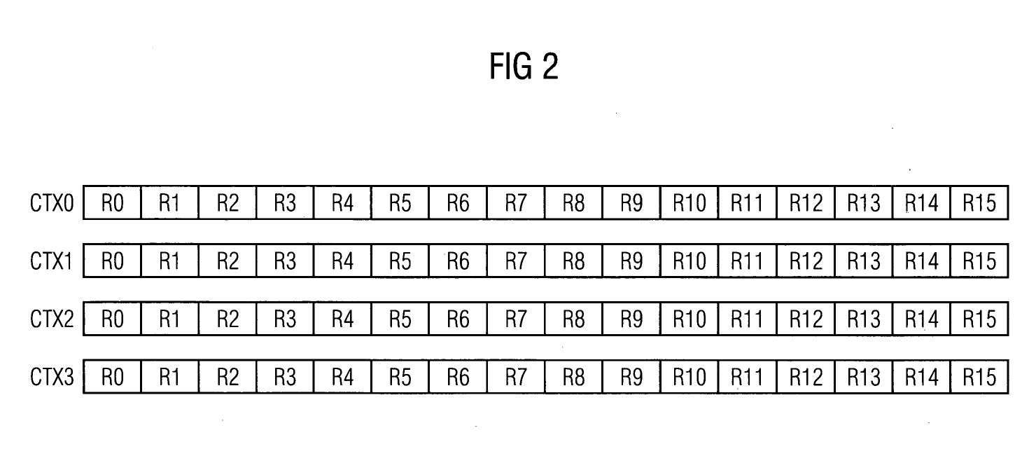

FIG. 2 schematically illustrates the structure of the register file. In the illustrated example, the register file comprises a total number of 64 registers which are organized in four contexts CTX0, CTX1, CTX2, CTX3. Each of the contexts CTX0, CTX1, CTX2, CTX3 comprises 16 registers R0, R1, . . . R15, i.e., each context CTX0, CTX1, CTX2, CTX3 has its own set of registers. Further, the illustration of FIG. 2 shows that for each register in a context, there exists a corresponding register in the other contexts. For example, for the register R0 in context CTX0, there exists corresponding registers R0 in the contexts CTX1, CTX2, CTX3. In the above concept of sharing registers, a result which is to be written into a register of one context CTX0, CTX1, CTX2, CTX3 will also be written into the corresponding registers of the other contexts, if the register sharing information specifies that this register is shared between the contexts.

For example, if a result is to be written into register R3 of context CTX0, and the register sharing information specifies that register R3 of context CTX0 is shared with context CTX1, the result will also be written into register R3 of context CTX1.

In the following, the concept of register sharing will be further explained by referring to a specific programming model according to an embodiment of the invention. According to the embodiment, each register can be declared in its context as:

“local” to its own context or

“global” to a set of contexts.

A register which is not “local” to its own context and not “global” to any other context is “locked”, i.e., no standard instruction can modify its value. In this respect, a “standard instruction” is a data processing instruction which is not explicitly dedicated for managing the data sharing process.

When a local register is written by a data processing instruction running in a given context, the updated value can be read only by other instructions running in the same context. Conversely, when a global register is written by a data processing instruction in a given context, the updated value in this context can also be read by other instructions running in the set of contexts to which this register has been declared global. This is a consequence of the above concept that for a shared or global register the result of a data processing instruction is also written into the corresponding registers of the other contexts.

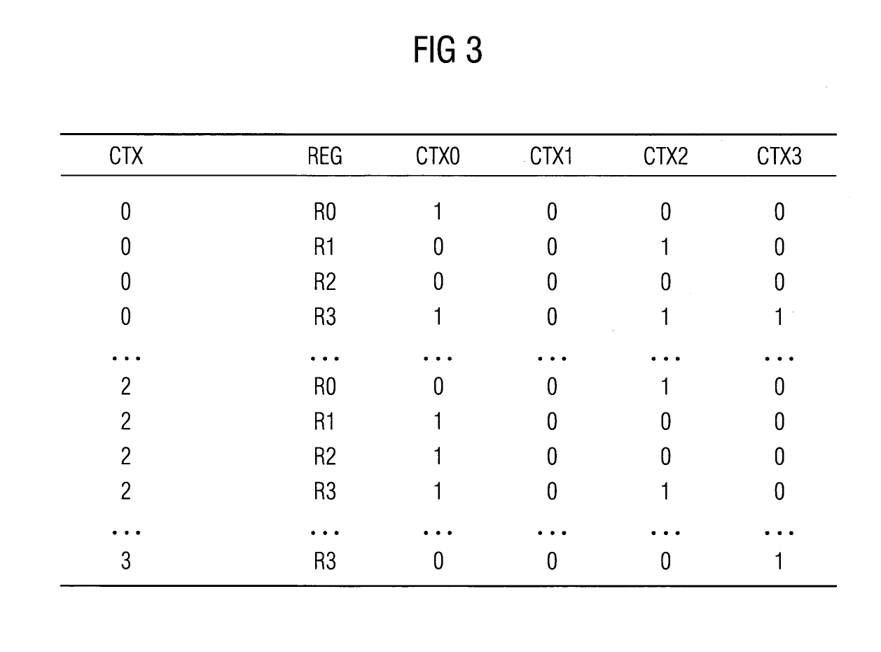

In the following, an example of a register sharing situation will be explained by referring to FIG. 3. FIG. 3 shows a table which contains exemplary register sharing information. The table provides four bits of register sharing data for each of the registers. Each of these bits pertains to a specific context. The status of the bits indicates whether a register is declared as global or not. In particular, a value of “1” means that the register is declared as global, and a value of “0” means that the register is not global.

By this means, different types of communication can be established between a first context and a second context: If in the first context, a register is declared global with respect to the second context and not with respect to the first context, and in the second context the corresponding register is declared as global with respect to the first context and not with respect to the second context, there is a two-way communication between the contexts. If in the first context the register is declared global with respect to the second context, and in the second context the register declared global with respect to the second context and not with respect to the first context, there is a one-way communication from the first context to the second context. If a register is declared as global with respect to the first context and with respect to the second context in both of the first context and the second context, the register is “shared” between the contexts.

In the case of the exemplary register sharing information of FIG. 3, the situation is as follows: In context CTX0, register R0 is local, register R1 is two-way communicating with context CTX2, register R2 is locked, and register R3 is shared with context CTX2 and one-way communicating with context CTX3. In context CTX2, register R0 is local, register R1 is two-way communicating with context CTX0, register R2 is one-way communicating with context CTX0, and register R3 is shared with context CTX0. In context CTX3, register R3 is local.

Further, a broadcast situation can be established by declaring a register in one context as global with respect to all other contexts, and a register can be totally locked by declaring the register as not global with respect to all contexts. A locked register can be released by changing the register sharing information. According to an embodiment, it is also possible to override a locked register using a special feature of an instruction provided to implement a “load-lock/store-conditional” synchronization, semaphores or barriers.

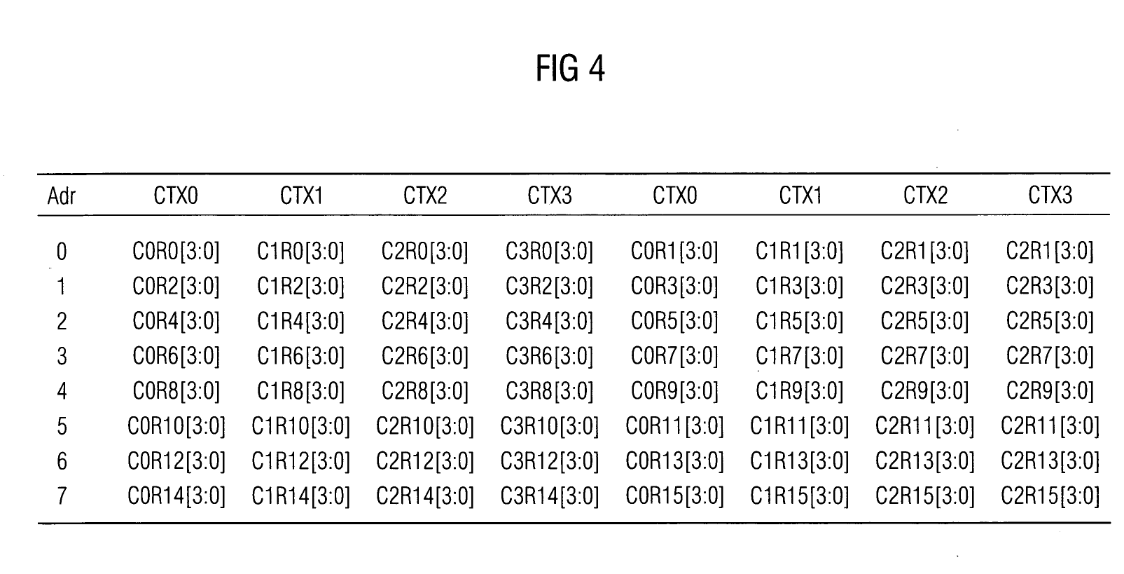

According to an embodiment, the register sharing table is mapped into a general purpose memory, e.g., the memory 12. In particular, the register sharing table may be mapped at a configurable address and organized as illustrated in FIG. 4.

As illustrated in FIG. 4, for each of the registers of the register file, four bits of register sharing data are provided. By means of these four bits, the register sharing status of the register with respect to each of the contexts CTX0, CTX1, CTX2, CTX3 is encoded. It is to be understood, that for a different number of contexts, the number of bits required to encode the status of a register will be different. In the table of FIG. 4, the notation CxRy[z] means the status of register Ry of the context CTXx with respect to context CTXz. It is to be understood that other embodiments may use other forms of organizing the register sharing information in a memory.

According to an embodiment, dedicated instructions are provided to read and write the register sharing information. For this purpose, the processor core is provided with an interface with respect to the memory holding the register sharing information. According to an embodiment, atomic test mechanisms or write mechanisms are implemented. In this respect, “atomic” means that the test mechanism or write mechanism is accomplished within one clock cycle. An example of such dedicated instructions is a “lock” instruction, which locks the specified register.

Further, non-standard instructions may be provided which write into a register even if it is locked. According to an embodiment, a “set” instruction is used to set the value and lock a register. Further, a “set locked” instruction can be provided, which only writes if the register is locked and atomically declares the register as global with respect to all contexts.

According to an embodiment, non-standard instructions which write locked registers overwrite the received register sharing data with their own register sharing data. This may be implemented in the processing stage by a multiplexer which is controlled by an instruction decoder of the processor.

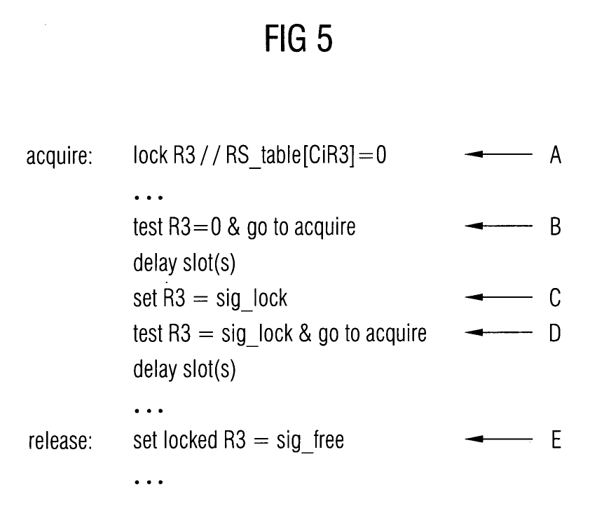

FIG. 5 shows exemplary assembly code for implementing a simple software lock. The lock comprises an “acquire” section and a “release” section. For example, the lock may be used in case of a resource, such as a content-addressed memory or a coprocessor, which is shared among different threads. The “acquire” section tries to acquire the ownership of this resource by writing its signature (sig_lock) into register R3, which is used to communicate among the threads. The register R3 may be an administration register or the like. The release section writes a free signature into the register R3 which indicates that the resource is free (sig_free), signaling that the ownership of the resource can be passed to another thread.

In FIG. 5, the different portions of the code are labeled from A to E. At A, the acquire section starts with locking the register R3 in the current context (context “i”) and declaring it shared among all the remaining contexts. If any context writes to the register R3, the written value is visible to the current context. At B, it is checked if the lock has been released. If this is not the case, it is returned to the starting point of the acquire section. That is to say, the method waits until another thread releases the lock. When this happens, at C, it is tried to acquire the lock by writing the lock signature (sig_lock) into the register R3. If this succeeds, the register is declared “shared” among all threads atomically, i.e., in the same clock cycle. However, this might fail because another thread has been faster to acquire the lock and, in doing this, has removed the lock on the register R3. Accordingly, at D, after trying to acquire the lock, it is ensured that the lock signature (sig_lock) is actually in the register R3. At E, the release section releases the lock by writing the free signature into the register R3 and atomically declaring the register as globally shared.

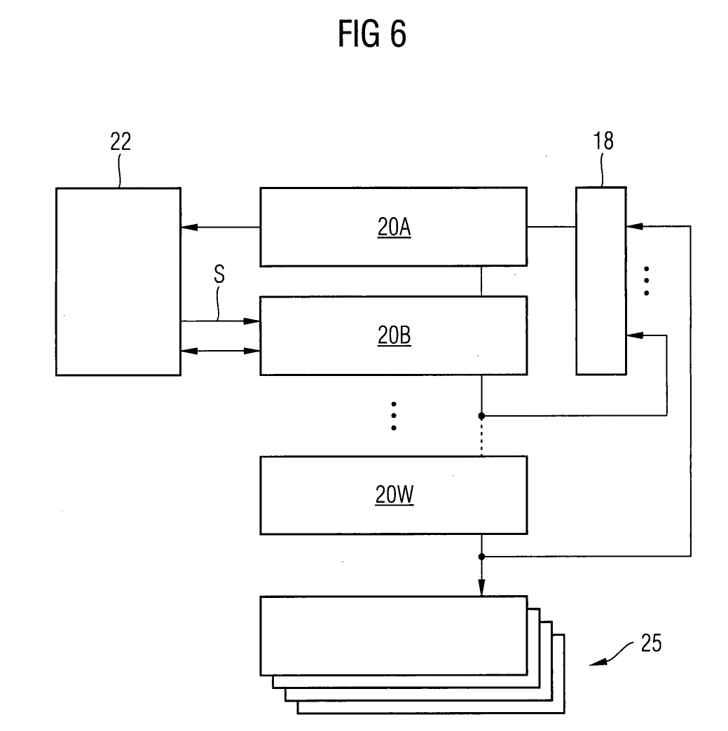

FIG. 6 shows a processor architecture according to a further embodiment of the invention. In many respects, the processor architecture according to FIG. 6 corresponds to that of FIG. 1. In particular, a memory 22 is provided which is similar to the memory 12 of FIG. 1, and a register file 25 is provided which is similar to that of FIG. 1. However, as compared to the processor architecture of FIG. 1, the processor architecture according to FIG. 6 comprises a plurality of processing stages 20A, 20B, . . . , 20W. The processing stage 20B will in the following be regarded as that processing stage in which the data processing instructions are executed. However, it is to be understood that data processing instructions may also be executed at other processing stages. At the processing stage 20W, the results of the data processing instructions are written into the register file 25. Accordingly, the processing stage 20W implements the functions as described for the write control 14 of the processor architecture of FIG. 1, i.e., it controls writing of the result of a data processing instruction into one or more registers of the register file 25 on the basis of the register sharing information. For this purpose, the register sharing information, which is received from the memory 22 by the processing stage 20B, is propagated through the processing stages up to the processing stage 20W.

The operation of the processor can be described as follows: The processing stage 20A accesses the registers of the register file 25 so as to obtain arguments for the data processing instruction to be carried out and also accesses the memory 22 so as to obtain register sharing data S with respect to the registers holding the arguments for the data processing instruction to be carried out. The register sharing data S is returned to the processing stage 20B, where the data processing instruction is executed. The result of the data processing instruction and the register sharing data are propagated from the processing stage 20B throughout the following processing stages up to the processing stage 20W, where the result is written into the registers for the register file 25 according to the register sharing data. This is accomplished as explained above with reference to FIGS. 1-4.

The processor according to the architecture of FIG. 6 further comprises a forwarding logic 18. The forwarding logic 18 forwards a result of a data processing instruction to other processing stages, thereby bypassing the result produced by a previous processing stage. According to the illustrated embodiment, results from the processing stages 20B-20W are bypassed to the processing stage 20A. This allows for taking into account that a data processing instruction may have modified the value of a register, but the modified value is still being propagated through the processing stages and has not yet been written into the register file at the processing stage 20W. Accordingly, the processing stage 20A may retrieve an “incorrect” value from the register file. By bypassing the values which are to be written into the register file to the processing stage 20A, an incorrect value obtained from the register file 25 can be overwritten with the correct value which is to be written into the register file 25.

According to an embodiment, the forwarding logic 18 is supplied with the register sharing information related to the result propagated from a processing stage. By this means, the specific situation of the above-described register sharing concept can be taken into account in the forwarding logic 18.

That is to say, the forwarding logic 18 is also provided with information concerning the context into which a result is to be written. Only if the context from which a register is read and the context into which a result is to be written match, the forwarding logic replaces the value read from the register with the value to be written into the register.

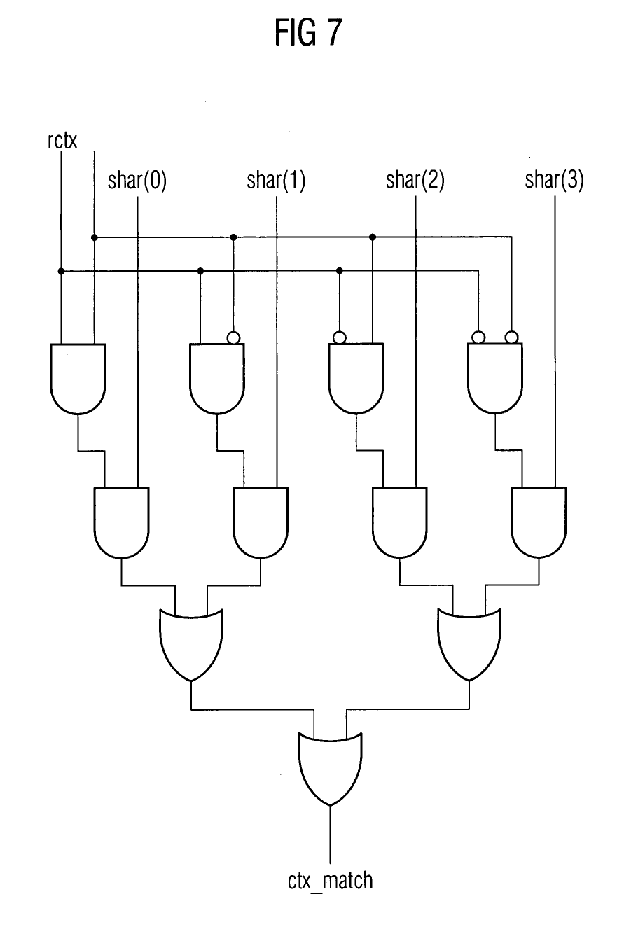

FIG. 7 illustrates circuitry of the forwarding logic to implement the above-mentioned context matching evaluation, according to an embodiment of the invention. The circuitry is supplied with a two-bit signal rctx representing the context from which a register is read. Further, the circuitry is supplied with a four-bit signal shar[0:3] representing the four-bit register sharing data of the register, i.e., a data signal corresponding to the entries CxRy[3:0] of the table as illustrated in FIG. 4. If the context from which a value is read and the context into which a value is to be written match, a matching signal CTX_match at the output of a circuitry assumes a value, e.g., a logic “1”, indicating that the read value must be replaced with the value to be written, provided that also the registers correspond to each other, i.e., the value which is being read from a context originates from the same architectural register of that context as the one architectural register of that context as the one architectural register of the other context to which the value shall be written.

It is to be understood that according to other embodiments the forwarding logic may use other types of logic circuitry to implement the context matching evaluation. Further, it is to be understood that the forwarding logic may actually comprise a plurality of portions for performing the context matching evaluation, depending on the number of registers which can be read in parallel.

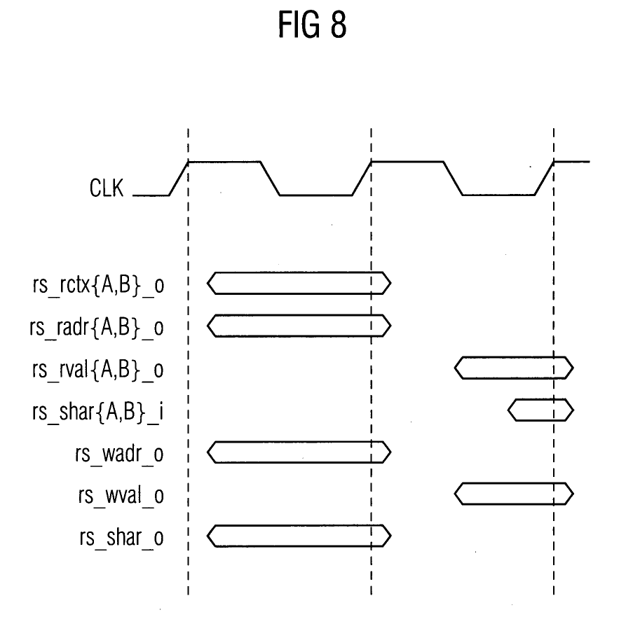

FIG. 8 illustrates an example for the timing of accesses from the processing stages to the memory holding the register sharing information. This timing may be applied both in the processor architecture according to FIG. 1 and in the processor architecture according to FIG. 6. In the illustrated example, the interface is implemented so as to allow simultaneous access by two read ports and one write port. By having two read ports, it is possible to obtain register sharing data for two different registers into which two results of a data processing construction are to be written. This is to account for specific types of instructions which return two results rather than only one result and thus require two registers for storing the results. Of course, in case of instructions returning more than two results, the interface could be provided with even more read ports, corresponding to the maximum number of results returned by a data processing instruction of the processor.

In FIG. 8, the signals have been labeled as follows:

rs_rctx{A,B}_o: context from which the table entry for a register shall be read, the characters A and B distinguish between the first read port A and the second read port B. The signal has two bits allowing to distinguish between four different contexts.

rs_radr{A,B}_o: number of the register whose table entry shall be read. The characters A,B distinguish between the first read port A and the second read port B. The signal comprises four bits, thus allowing to distinguish between 16 registers.

rs_rval{A,B}_o: indication that a read operation must take place. The characters A, B distinguish between the first read port A and the second read port B.

rs_shar{A,B}_i: table entry information in reply to the read operation. The characters A,B distinguish between the first read port A and the second read port B. The signal comprises four bits, corresponding to the size of the table entries as explained in connection with FIG. 4.

rs_wadr_o: number of the register whose table entry shall be written. The signal comprises four bits. The table entry address is specified by the first three bits rs_wadr_o[3:1]. The last bit rs_wadr_{—}[0] specifies whether to take the upper or lower 16 bits in the memory structure as illustrated in FIG. 4.

rs_wval_o: indication that a write operation must take place.

rs_shar_o: table entry information that shall be written by the write operation. The signal comprises 16 bits. Accordingly, several table entries are written simultaneously.

CLK: clock signal.

As illustrated in FIG. 8, a read and write operation is completed within two clock cycles. Read and write data can be provided early in the first clock cycle, and the read and write control signals are delivered later in the second clock cycle.

According to an embodiment, the interface allows for synchronization of multiple processor cores. In this embodiment, the memory accessed via the interface is not write-through across multiple processors, i.e., if at the same time an entry is read and written, the result returned to the reader is not the one written by the reader. Instead the value written by the writer winning the arbitration is returned. Obviously, if the processor core is the sole reader and writer this means that the processor core wins the arbitration and the register sharing table actually is write-through for this processor core. According to an embodiment, this feature can be used to find out whether a store-conditional operation of a processor core has unlocked a register because it writes and reads the register entry in the register sharing table at the same time. If the read value means that the register is still locked, the processor core has lost the arbitration.

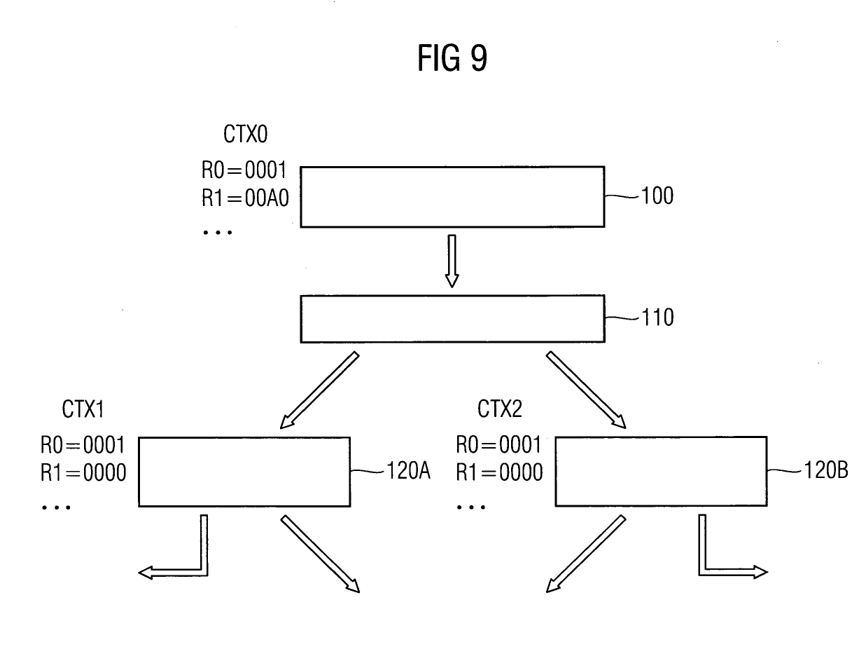

FIG. 9 shows an example for the use of shared registers in a communication device, e.g., in a protocol processor. By way of example, a method is illustrated which takes data packets from one queue, e.g., an input queue, analyzes the data packets, e.g., by parsing their header, and distributes the data packets into two further queues, e.g., two output queues according to their type. It is assumed that each of the output queues may contain only a maximum of ¼ of the total number of received data packets. Accordingly, it is necessary for each queue to check whether the respective packet count for the output queues is in excess of ¼ of the total packet count.

The total packet count is updated in a first context CTX0 by incrementing it upon receiving a data packet. The total packet count is stored in register R0 of the first context CTX0. This is accomplished in method step 100.

In method step 110, a data packet is dequeued from the input queue and the header of the data packet is parsed so as to determine the packet type. According to the packet type, the data packet is forwarded to either one of the output queues. For packets of a first type, the method continues with method step 120A. For packets of a second type, the method continues with method step 120B. In method step 120A, it is checked whether the first output queue is full. This is accomplished on the basis of a second context CTX1. The register R0 of the second context CTX1 is shared with the register R0 of the first context CTX0. By this means, the total packet count can be transferred from the first context CTX0 to the second context CTX1, where it is necessary to evaluate whether the packet count of the first output queue is in excess of ¼ of the total packet count. If this is the case, the data packet is discarded.

Similarly, at method step 120B, it is checked whether the second output queue is full. This is accomplished on the basis of the third context CTX2. The register R0 of the third context CTX2 is shared with the register R0 of the first context CTX0. By this means, the total packet count can be transferred from the first context CTX0 to the third context CTX2, where it is necessary to evaluate whether the packet count of the second output queue is in excess of ¼ of the total packet count.

It is to be understood, that the above-described embodiments and examples have been provided only for the purpose of illustrating the present invention. As will be apparent to the skilled person, the invention may be applied in a variety of different ways, which may deviate from the above-described embodiments. For example, the described concepts are not limited to processors in a computer system or in a communication device. Further, these concepts may be applied to single core processors or to multi-core processors. The concepts may be applied to share information between different threads or processes running on a processor. However, it is also possible to apply these concepts in other situations where sharing of information is desired.

What is claimed is:

1. A method of sharing registers in a processor, the method comprising:
executing a data processing instruction;
obtaining a result of the data processing instruction, the result to be written into a register of the processor; and
obtaining a register sharing information so as to control writing of the result into the register and/or at least one further register of the processor.

2. The method according to claim 1, further comprising:
forwarding the result of the data processing instruction between different processing stages of the processor.

3. The method according to claim 2, wherein said forwarding is accomplished taking into account said register sharing information.

4. The method according to claim 3, wherein said forwarding of the result includes an evaluation whether said register or said at least one further register are used in a processing stage.

5. The method according to claim 1, wherein said writing of said result into the register and/or the at least one further register is accomplished within one clock cycle.

6. The method according to claim 1, wherein said register and said at least one further register are associated with different contexts of a register file.

7. The method according to claim 1, wherein said register sharing information specifies whether said register is global with respect to said at least one further register.

8. The method according to claim 1, further comprising:
configuring said register sharing information to control the transfer of data between different instruction threads running on the processor.

9. The method according to claim 1, further comprising:
providing a table memory to hold said register sharing information.

10. The method according to claim 1, wherein said result of the data processing instruction does not depend on said register sharing information.

11. A processor, comprising:
a processing stage to execute data processing instructions;
a register file having a plurality of registers; and
a write control to control writing of a result of a data processing instruction into the register file, wherein the write control is supplied with register sharing information to control writing of said result into the register of the register file and/or at least one further register of the register file.

12. The processor according to claim 11, further comprising forwarding logic to forward said result of the data processing instruction from said processing stage to at least one further processing stage.

13. The processor according to claim 12, wherein the forwarding logic is controlled on the basis of said register sharing information.

14. The processor according to claim 12, wherein the forwarding logic comprises evaluation circuitry to evaluate whether said register and/or at least one further register into which said result is to be written according to the register sharing information are used in a further processing stage.

15. The processor according to claim 11, further comprising a table memory to hold said register sharing information.

16. The processor according to claim 15, wherein said table memory can be accessed in one write operation and at least one read operation within one clock cycle.

17. The processor according to claim 15, wherein the processor comprises a plurality of processor cores coupled to the table memory.

18. A computer system, comprising:
a processor to execute a program code, wherein said processor comprises:
a register file having a plurality of registers;
a processing stage to execute data processing instructions of the program code; and
a write control to control writing of a result of a data processing instruction into the register file, wherein the write control is supplied with register sharing information to control writing of said result into a register and/or at least one further register of the register file.

19. The computer system according to claim 18,
wherein said processor supports a plurality of threads of the program code; and
wherein said register file comprises a corresponding set of registers for each of the threads.

20. The computer system according to claim 19, wherein said register sharing information defines whether a register of a thread is declared as global with respect to a corresponding register of at least one further thread.

21. A communication device, comprising:
a protocol processor to handle data packets, wherein said protocol processor comprises:
a register file having a plurality of registers;
a processing stage to execute data processing instructions; and
a write control to control writing of a result of a data processing instruction into the register file, wherein the write control is supplied with register sharing information to control writing of said result into a register of the register file and/or at least one further register of the register file.

22. The communication device according to claim 21, wherein said protocol processor is an embedded component of the communication device.
